(19) United States
(12) Patent Application Publication
(10) Pub. No.: US 2026/0146008 A1
(43) Pub. Date: May 28, 2026

(54) ORGANIC MATERIAL BASED COMPLEX NUTRIENT, PROMOTED BY BIOLOGICAL ACTIVE ENHANCEMENT

(71) Applicant: SABIC AGRI-NUTRIENTS COMPANY, Riyadh (SA)

(72) Inventors: Mohamed AL-RABHI, Riyadh (SA); Aghaddin MAMEDOV, Riyadh (SA); Samik GUPTA, Bangalore (IN); Bedour AL-SABBAN, Thuwal (SA); Raeid AL-SADEG, Thuwal (SA)

(73) Assignee: SABIC AGRI-NUTRIENTS COMPANY, Riyadh (SA)

(21) Appl. No.: 19/129,611

(22) PCT Filed: Nov. 14, 2023
(86) PCT No.: PCT/IB2023/061497

§ 371 Date: May 13, 2025

(30) Foreign Application Priority Data
Nov. 15, 2022 (IN) 202211065378

(51) Int. Cl. C05C 5/00; C05G 5/30; C05G 5/40

(52) U.S. Cl. CPC C05C 5/005; C05G 5/30; C05G 5/40

(57) ABSTRACT

Biological-enhanced fertilizer composition comprising a fertilizer, an organic material, and at least one biological active enhancer capable of breaking down the organic material and methods of making and using the same. In some embodiments, the compositions encapsulate the fertilizer and/or at least one biological active enhancer in the organic material. In some embodiments, the compositions coat the organic material with at least one biological active enhancer.

### CROSS-REFERENCE TO RELATED APPLICATIONS

This application claims priority to the and the benefit of Indian Application No. 202211065378, filed Nov. 15, 2022, the contents of which is incorporated into the present application by reference in its entirety.

### BACKGROUND

### A. Field of the Invention

The invention generally concerns biological-enhanced fertilizers and methods of making and using the same, wherein the biological-enhanced fertilizer comprises at least one fertilizer, at least one biological active enhancer, and at least one organic material that can be broken down by at least one biological active enhancer.

### B. Description of Related Art

Soil nutrients, such as nitrogen, phosphorus, potassium, and sulfur, as well as trace elements such as iron, zinc, copper, and magnesium, are useful for achieving thriving agriculture and growth of plants. Upon repeated planting cycles, the quantity of these nutrients in the soil may be depleted, resulting in reduced plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Soil does not comprise just nutrients, it also comprises mineral substances, organic matter, enzymes, and microorganisms. The role and activities of enzymes and microorganisms in the soil microecological area is important for nutrient uptake by plants (e.g., via the root system), as beneficial microorganisms and enzymes in the soil can directly participate in formation of soil fertility, e.g., conversion of substances and energy in the soil, formation and decomposition of humus and/or other organic material, release and/or fixation of trace elements and/or nutrients, fixation of nitrogen, etc.

### SUMMARY

A discovery has been made that provides a solution to at least some of the problems associated with production, characteristics of, and/or use of combination fertilizers. In particular, disclosed herein are biological-enhanced fertilizer compositions comprising a fertilizer, an organic material, and at least one biological active enhancer capable of breaking down the organic material and methods of making and using the same. In some embodiments, the compositions encapsulate the fertilizer and/or at least one biological active enhancer in the organic material. In some embodiments, the compositions coat the organic material with at least one biological active enhancer. Unlike many other approaches, disclosed herein are compositions and methods wherein the fertilizer can provide immediate nutrient, enzyme, and/or microorganism release as well as slow release of nutrients, enzymes, and/or microorganisms as the organic material is broken down by the biological active enhancer. The resulting complex fertilizer may be produced from raw materials with minimum carbon footprint, contributing to carbon neutrality. The organic material may be low cost and locally abundant as raw material; nitrogen content of the fertilizer may be derived directly from air via a combination of biological, chemical, or physical processes. Nitrogen content may be supplemented with synthesized ammonia, preferably green NH₃. Phosphorus content may be from naturally occurring Ca—P and Mg—P rocks. Potassium may be derived from oceanic sources. The fertilizer composition may be carefully designed for compatibility with a target enzymes' and/or microorganisms' biology and mode of action.

In some instances, once applied to the soil, the composition will first release an externally coated biological active enhancer such as a microorganism and/or enzyme, followed by organic decomposition to release nutrients and optionally internally protected and trapped nutrients, microorganisms, and/or enzymes. In some instances, chemically bonded nutrients will be slowly released. This process may allow for paced and slow release in the soil. Benefits from this composition include an increase in soil organic matter, enhancement of soil microorganism activity, and enrichment of soil by released nutrients. The biological active enhancer may in some instances lead to higher N, P, K and other nutrient accumulation, which may result in better growth, healthier crops, and higher yields.

In some embodiments, the biological active enhancer is a microorganism and/or an enzyme. The biological active enhancer may be homogenously mixed into the fertilizer and/or coated on the fertilizer. In some embodiments, the biological active enhancer is combined with the fertilizer with a dosing pump or with spray drying equipment.

In some aspects, the organic material is a cellulosic material and/or a lignin material. In some instances, the organic material is a modified cellulose and/or a modified lignin.

In some embodiments, the fertilizer comprises one or more granular fertilizer, preferably one or more of urea, diammonium phosphate, potassium sulfate, and/or a nitrogen phosphorus potassium (NPK) mix. In some embodiments, the fertilizer comprises urea. In some aspects, the fertilizer does not contain urea.

In some embodiments, fertilizer granulation comprises chemically reacting reactants to form the fertilizer in a solution, solidifying the fertilizer, and/or granulating the solidified fertilizer, wherein the biological active enhancer is contacted with the fertilizer before, after, and/or during granulation.

In some embodiments, the biological active enhancer is protected by addition of one or more physical protectants and/or by engineering methods (e.g., spray drying, freeze-drying, etc.). In some instances, the biological active enhancer is protected by an encapsulating agent, water-soluble additive (e.g., water-soluble protectants and/or water-soluble humectants), stabilizer additive, and/or a dispersant. In some embodiments, the biological active enhancer is encapsulated with a stabilizer. In some embodiments, the physical protectant is a molecule and/or enzyme derived from a thermophilic organism. In some embodiments, the engineering method comprises spray drying and/or freeze-drying.

In some embodiments, the biological active enhancer comprises a spore/cyst forming bacteria. In some embodiments, the biological active enhancer is comprised in a plurality of microorganisms and greater than, equal to, or any range therein of 50, 60, 70, 80, or 90% of the plurality of microorganisms are comprised in a spore or a cyst. In some embodiments, the microorganism has not been chemically induced to form spores/cysts. In some embodiments, the biological active enhancer has not been selected for heat tolerance. In some embodiments, the microorganism, when contacted with the fertilizer is not a chemically induced spore or cyst.

In some embodiments, the biological active enhancer comprises an enzyme. In some instances, the enzyme may break down the organic material. In some instances, the enzyme may break down a polysaccharide. In some instances, the enzyme may break down lignin or a modified lignin. In some instances, the enzyme may break down cellulose or a modified cellulose.

In some embodiments, provided herein is a biological-enhanced fertilizer produced by any of the methods described herein. In some embodiments, the biological-enhanced fertilizer is a powder, prill, and/or granule. In some embodiments, the biological-enhanced fertilizer is configured to have a longer fertilizer, enzyme, and/or microbe shelf-life relative to an otherwise comparable biological-enhanced fertilizer wherein the biological active enhancer is combined without being protected. In some embodiments, the biological-enhanced fertilizer is configured to have a greater bioavailability relative to an otherwise comparable biological-enhanced fertilizer wherein the biological active enhancer is combined without being protected.

In some embodiments, a biological-enhanced fertilizer can contain a fertilizer. In some instances, the fertilizer is a granulatable fertilizer. In some instances, the fertilizer is produced during the production/formation of the biological-enhanced fertilizer. In some embodiments, the biological-enhanced fertilizer may contain a nitrogen based fertilizer, a phosphate-based fertilizer, a potassium-based fertilizer, a urea-based fertilizer, a fertilizer providing nitrogen-phosphorus-potassium (NPK), or any combination thereof.

In some aspects, forming the biological-enhanced fertilizer may include addition of a organic material, a biological active enhancer, a fertilizer, and/or one or more additives (e.g., urea, calcium sulfate, phosphogypsum, water, etc.) into a fertilizer melt, a solidifying fertilizer melt, and/or a solid fertilizer.

In some embodiments, a biological-enhanced fertilizer comprises an additive. The additive can be a micronutrient, a secondary nutrient, or an organic agent, etc. In some instances, the additive can be kieserite, carnallite, magnesite, dolomite, boric acid, boron (B), copper (Cu), iron (Fe), manganese (Mn), molybdenum (Mo), zinc (Zn), selenium (Se), silicon (Si), free Ca, magnesium (Mg), elemental sulfur(S), neem oil, seaweed extract, bio-stimulants, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, etc. or any combination thereof.

In some embodiments, the biological-enhanced fertilizer composition can include a coating on the surface of the fertilizer granule and/or the process of forming the biological-enhanced fertilizer composition can include adding a coating on the surface of the biological-enhanced fertilizer granules. In some instances, the coating can contain one or more biological active enhancer, nutrients for a plant, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule. pH buffering agents, drying agents, etc. or any combination thereof. Non-limiting examples of a coating include an enzyme, a microorganism, a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound. The coating can be applied to the granule before drying, during drying of the granule, or after drying of the granule. The coating can be applied to the granule by spraying, pouring, mixing, blending, etc. A fluid bed sprayer or coater, a liquid spray mixer, a rotating drum or pan, spray coating at discharge point, a paddle mixer, etc. can be used.

In some instances, the biological-enhanced fertilizer composition can have a density greater than water (e.g., greater than 1.0 g/mL). In some instances, the biological-enhanced fertilizer composition can be comprised of one or more particles. In some embodiments, the biological-enhanced fertilizer composition of the present invention can have an average particle size of 1 millimeter (mm) to 5 mm, preferable about 2 mm to 4 mm.

Some aspects of the present disclosure are directed to a biological-enhanced fertilizer composition comprising ammonium phosphate and/or potassium nitrate and/or biological active enhancer encapsulated within the phosphorylated cellulosic and/or lignin material and/or the nitrate modified cellulosic and/or lignin material. In some aspects, the biological-enhanced fertilizer comprises ammonium phosphate and/or potassium nitrate and/or biological active enhancer absorbed and/or coated onto the surface of the biological-enhanced fertilizer composition.

Also disclosed in the context of the present invention are blended or compounded fertilizer compositions that include a plurality of biological-enhanced fertilizer compositions disclosed herein mixed with other fertilizers, micronutrients, secondary nutrients, or organic agents. The other fertilizers can be particulate in form. The biological-enhanced fertilizer and other fertilizers, micronutrients, secondary nutrients, or organic agents can be compatible with each other (e.g., can contact each other without having a chemical reaction take place).

In one aspect, a method to produce a biological-enhanced fertilizer composition comprising a fertilizer, an organic material, and a biological active enhancer is disclosed. The method may include combining the fertilizer, the organic material, and the biological active enhancer to form a homogeneous or substantially homogenous biological-enhanced fertilizer. The method may include combining the organic material and the fertilizer to form a core, and at least partially coating the core with the biological active enhancer. The method may include combining the organic material and the biological active enhancer to form a core, and at least partially coating the core with the fertilizer.

In some instances, the organic material and/or the fertilizer is produced by the method and the biological active enhancer is added to the produced organic material and/or fertilizer. As a non-limiting example, in some instances the method includes the steps of i) reacting a cellulosic material and/or lignin material with phosphoric acid to produce a phosphorylated cellulosic and/or lignin material (e.g., cellulosic phosphate and/or lignin phosphate), wherein at least a portion of the cellulosic and/or lignin material hydroxyl groups are phosphorylated, ii) reacting a cellulosic material and/or lignin material with nitric acid to produce a nitrate modified cellulosic and/or lignin material (e.g., cellulosic nitrate and/or lignin phosphate), wherein at least a portion of the cellulosic and/or lignin material hydroxyl groups are nitrated, iii) reacting a potassium compound with nitric acid to form potassium nitrate, iv) reacting phosphoric acid with a source of ammonia to produce ammonium phosphate, and v) combining the phosphorylated cellulosic and/or lignin material, nitrate modified cellulosic and/or lignin material, the potassium nitrate, and the ammonium phosphate to form a fertilizer composition. In some instances, the fertilizer composition comprises ammonium phosphate and/or potassium nitrate encapsulated within the phosphorylated cellulosic and/or lignin material and/or the nitrate modified cellulosic and/or lignin material. In some instances, the method includes combining the biological active enhancer with the phosphorylated cellulosic and/or lignin material, nitrate modified cellulosic and/or lignin material, the potassium nitrate, and the ammonium phosphate to form a fertilizer composition. In some aspects, the method includes the step of vi) drying the fertilizer composition. In some aspects, the method includes vii) coating the fertilizer composition with fertilizer and/or biological active enhancer. In some aspects, steps i), ii), iii), and iv) are performed in a single vessel. In some aspects, steps i), ii), iii), iv), and v) are performed in a single vessel. In some aspects, steps i) and iv) are performed in a first vessel and steps ii) and iii) are performed in a second vessel. In some aspects, a stoichiometric excess of phosphoric acid is present in step i) and at least a portion of the phosphoric acid reacted in step iv) comprises the stoichiometric excess of phosphoric acid used in step i). In some aspects, a stoichiometric excess of nitric acid is present in step ii) and at least a portion of the nitric acid reacted in step iii) comprises the stoichiometric excess of nitric acid used in step ii).

In some aspects, reacting the cellulosic material and/or lignin material with the phosphoric acid and/or nitric acid comprises combining a solution of the cellulosic material and/or lignin material with a phosphoric acid and/or nitric acid solution. In other aspects, reacting the cellulosic material and/or lignin material with the phosphoric acid and/or nitric acid comprises adding the cellulosic material and/or lignin material (neat, i.e., with no additional solvent) to a phosphoric acid and/or nitric acid solution. In some aspects, the cellulosic material and/or lignin material is reacted with the phosphoric acid and/or nitric acid at a weight ratio of 1:1 to 1:5. The weight ratio of cellulosic material and/or lignin material to phosphoric acid and/or nitric acid may be any one of, less than, greater than, or between 1:1, 1:2, 1:3, 1:4, 1:5, or any range derivable therein. In some aspects, reacting the cellulosic material and/or lignin material with the phosphoric acid and/or nitric acid comprises reacting at a temperature from about 25° C. to about 200° C., preferably from about 30° C. to about 175° C., more preferably at a temperature of about 35° C. to 150° C. Reacting the cellulosic material and/or lignin material with the phosphoric acid and/or nitric acid may be performed at a temperature of any one of, less than, greater than, between, or any range thereof of 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, and 200° C. In some aspects, reacting the cellulosic material and/or lignin material with the phosphoric acid and/or nitric acid produces material in the form of a gel.

In some aspects, the source of ammonia comprises a solution of ammonium hydroxide, ammonium, ammonium carbonate, ammonia gas, succinimide, and/or phthalimide. In some aspects, reacting the phosphoric acid with the source of ammonia comprises reacting at a temperature ranging from about 20° C. to about 170° C. preferably from about 30° C. to about 140° C., more preferably at a temperature of about 35° C. to 120° C. Reacting the phosphoric acid with the source of ammonia may be performed at a temperature of any one of, less than, greater than, between, or any range thereof of 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, and 170° C.

In some aspects, the cellulosic and/or lignin material comprises cellulose, lignin, ethylcellulose, lignin-modified phenolic compounds, methylcellulose, hydroxypropyl cellulose, hydroxyethyl cellulose, carboxymethyl cellulose, products of ammoxidation of lignin, and/or products of Mannich reaction of lignin.

In some aspects, the potassium compound comprises one or more of potassium hydroxide, potassium carbonate, potassium nitrate, potassium chloride, potassium phosphate, potassium sulfate, potassium bicarbonate, potassium oxide, potassium permanganate, potassium bromide, and/or potassium iodide.

In some aspects, the fertilizer composition further comprises an additional nutrient, wherein the additional nutrient is added before, during, and/or after formation of the biological-enhanced fertilizer composition, such as before, during, and/or after formation of a granule.

In some embodiments of the present invention, methods of fertilizing are described. A method can include applying a plurality of a biological-enhanced fertilizer composition, and/or blended or compounded fertilizer compositions described herein to a portion of a soil, a crop, or a combination of the soil and the crop. In some embodiments, the soil is at least partially or fully submerged under water (e.g., rice paddy crops) and the granules sink in the water to contact the soil.

Also disclosed are the following Aspects 1 to 20 of the present invention.

Aspect 1 is a biological-enhanced fertilizer composition comprising:
a fertilizer;
an organic material;
at least one biological active enhancer capable of breaking down the organic material.

Aspect 2 is the biological-enhanced fertilizer composition of aspect 1, wherein the organic material comprises one or more of a polysaccharide, a modified polysaccharide, a lignin, or a modified lignin.

Aspect 3 is the biological-enhanced fertilizer composition of any one of aspects 1 and 2, wherein at least one biological activity enhancer comprise one or more of a microbe or an enzyme.

Aspect 4 is the biological-enhanced fertilizer composition of any one of aspects 1 to 3, wherein at least one biological activity enhancer comprises an enzyme.

Aspect 5 is the biological-enhanced fertilizer composition of any one of aspects 1 to 4, wherein at least one biological activity enhancer comprises a microbe.

Aspect 6 is the biological-enhanced fertilizer composition of any one of aspects 1 to 5, wherein the fertilizer comprises one or more of a nitrogen fertilizer, a phosphorus fertilizer, a potassium fertilizer, a calcium plant nutrient, a magnesium plant nutrient, a sulfur plant nutrient, an iron plant nutrient, a copper plant nutrient, a zinc plant nutrient, or a manganese plant nutrient.

Aspect 7 is the biological-enhanced fertilizer composition of any one of aspects 1 to 6, wherein the organic material at least partially surrounds at least a portion of the fertilizer.

Aspect 8 is the biological-enhanced fertilizer composition of any one of aspects 1 to 7, wherein the organic material at least partially surrounds at least one biological active enhancer.

Aspect 9 is the biological-enhanced fertilizer composition of any one of aspects 1 to 8, wherein at least one biological active enhancer at least partially coats the organic material.

Aspect 10 is the biological-enhanced fertilizer composition of any one of aspects 1 to 9, wherein at least one biological active enhancer at least partially coats the organic material and wherein the organic material at least partially surrounds at least one biological active enhancer.

Aspect 11 is the biological-enhanced fertilizer composition of aspect 10, wherein the at least one biological active enhancer at least partially coated by the organic material is a different biological active enhancer than the at least one biological active enhancer at least partially surrounded by the organic material.

Aspect 12 is the biological-enhanced fertilizer composition of any one of aspects 1 to 11, wherein the fertilizer comprises one or more of urea, diammonium phosphate, potassium sulfate, and/or a nitrogen phosphorus potassium (NPK) mix.

Aspect 13 is the biological-enhanced fertilizer composition of any one of aspects 1 to 12, wherein the fertilizer comprises one or more of monoammonium phosphate, potassium nitrate, a cellulose comprising phosphate moieties, and/or a cellulose comprising nitrate moieties.

Aspect 14 is a method of making a biological-enhanced fertilizer composition of any one of aspects 1 to 13, the method comprising:
combining the fertilizer, the organic material, and the at least one biological active enhancer; and
drying to form the biological-enhanced fertilizer composition.

Aspect 15 is the method of aspect 14, wherein the at least one biological active enhancer is combined with the organic material by mixing the at least one biological active enhancer and the organic material to at least partially surround the at least one biological active enhancer with the organic material.

Aspect 16 is the method of any one of aspects 14 to 15, wherein the at least one biological active enhancer is combined with the organic material by at least partially coating the organic material with the at least one biological active enhancer.

Aspect 17 is the method of any one of aspects 14 to 16, wherein the organic material comprises cellulose comprising phosphate moieties and/or cellulose comprising nitrate moieties, and wherein the method further comprises reacting cellulose with nitric acid to form the cellulose comprising nitrate moieties and/or reacting cellulose with phosphoric acid to form the cellulose comprising phosphate moieties.

Aspect 18 is the method of any one of aspects 14 to 17, wherein the fertilizer comprises
monoammonium phosphate and/or potassium nitrate, and wherein the method further comprises reacting phosphoric acid with a source of ammonia to form the monoammonium phosphate and/or reacting potassium hydroxide with nitric acid to form the potassium nitrate.

Aspect 19 is the method of any one of aspects 14 to 18, wherein the fertilizer is combined with the organic material by mixing the fertilizer and the organic material to at least partially surround the fertilizer with the organic material.

Aspect 20 is a method for fertilizing agricultural crops comprising applying the biological-enhanced fertilizer composition of any one of aspects 1 to 13.

The following includes definitions of various terms and phrases used throughout this specification.

The term “fertilizer” is defined as a material applied to soils or to plant tissues to supply one or more plant nutrients essential or beneficial to the growth of plants and/or stimulants or enhancers to increase or enhance plant growth. Non-limiting examples of fertilizers include materials having one or more of urea, ammonium nitrate, calcium ammonium nitrate, urea calcium sulfate adduct, one or more superphosphates, binary NP fertilizers, binary NK fertilizers, binary PK fertilizers, NPK fertilizers, molybdenum, zinc, copper, boron, cobalt, and/or iron. In some embodiments, fertilizers include agents that enhance plant growth and/or enhance the ability for a plant to receive the benefit of a fertilizer, such as, but not limited to biostimulants, urease inhibitors, and nitrification inhibitors.

The term “plant nutrient” is defined as a compound or element essential or beneficial to the growth of plants and/or stimulants or enhancers to increase or enhance plant growth.

The term “microbe” or “microorganism” can include bacteria, fungi, protists, and/or archaea.

The term “micronutrient” is defined as a chemical element or substance used in trace amounts for the normal growth and development of a plant. Non-limiting examples of micronutrients include B, Cu, Fe, Mn, Mo, Zn, Se, and Si or compounds thereof.

The term “secondary nutrient” is defined as a chemical element or substance used in moderate amounts for plant growth and are less likely to limit crop growth in comparison to N, P, and K. Non-limiting examples of secondary nutrients include Ca, Mg, and S.

The term “organic agent” is defined as a substance that is produced by or part of an organism. Non-limiting examples of organic agents suitable for a fertilizer include neem oil, seaweed extract, bio-stimulants, char, biowaste, ashes from incineration of animal waste or animal tissues, and diatomaceous earth.

The term “modified polysaccharide” is defined as a polysaccharide that has been chemically modified to contain covalently attached chemical moieties. Examples of a modified polysaccharide include, but are not limited to, cellulose acetate, cellulose triacetate, carboxymethylcellulose, cellulose phosphates, ammonium cellulose phosphates, cellulose-graft-poly (acrylamide), etc.

The term “modified lignin” is defined as a lignin that has been chemically modified to contain covalently attached chemical moieties. Examples of a modified lignin include, but are not limited to, lignin-modified phenolic compounds, products of ammoxidation of lignin, and/or products of Mannich reaction of lignin, etc.

The term “granule” can include a solid material. A granule can have a variety of different shapes, non-limiting examples of which include a spherical, a puck, an oval, a rod, an oblong, or a random shape.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %.” “vol. %.” or “mol. %” refers to a weight percentage of a component, a volume percentage of a component, or molar percentage of a component, respectively, based on the total weight, the total volume of material, or total moles, that includes the component.

In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The biological-enhanced fertilizer composition and methods of producing the biological-enhanced fertilizer composition of the present invention can “comprise,” “consist essentially of” or “consist of” particular ingredients, components, compositions, steps, etc. disclosed throughout the specification. With respect to the transitional phase “consisting essentially of,” in one non-limiting aspect, a basic characteristic of the biological-enhanced fertilizer of the present invention is the presence of a fertilizer, an organic material, and at least one biological active enhancer capable of breaking down the organic material.

### BRIEF DESCRIPTION OF THE DRAWINGS

Advantages of the present invention may become apparent to those skilled in the art with the benefit of the following detailed description and upon reference to the accompanying drawings.

FIG. 1 depicts an exemplary biological-enhanced fertilizer production method.

FIG. 2 depicts an exemplary biological-enhanced fertilizer production method.

FIG. 3 depicts an exemplary biological-enhanced fertilizer.

FIG. 4 depicts an exemplary biological-enhanced fertilizer.

While the invention is susceptible to various modifications and alternative forms, specific embodiments thereof are shown by way of example in the drawings. The drawings may not be to scale.

### DETAILED DESCRIPTION

Non-limiting aspects of the present invention are discussed in further detail in the following sections. Biological-enhanced fertilizer composition comprising a fertilizer, an organic material, and at least one biological active enhancer capable of breaking down the organic material and methods of making and using the same are disclosed herein. In some embodiments, the compositions encapsulate the fertilizer and/or at least one biological active enhancer in the organic material. In some embodiments, the organic material is coated with at least one biological active enhancer. Unlike many other approaches, the biological-enhanced fertilizer can provide immediate nutrient, enzyme, and/or microorganism release as well as slow release of nutrients, enzymes, and/or microorganisms as the organic material is broken down by the biological active enhancer. The resulting complex fertilizer may be produced from raw materials with minimum carbon footprint, contributing to carbon neutrality. The organic material may be low cost and locally abundant as raw material; nitrogen content of the fertilizer may be derived directly from air via a combination of biological, chemical, or physical processes. Nitrogen content may be supplemented with synthesized ammonia, preferably green NH₃. Phosphorus content may be from naturally occurring Ca—P and Mg—P rocks. Potassium may be derived from oceanic sources. The fertilizer composition may be carefully designed for compatibility with a target enzymes' and/or microorganisms' biology and mode of action.

In some instances, once applied to the soil, the composition will first release an externally coated biological active enhancer such as a microorganism and/or enzyme, followed by organic decomposition to release nutrients and optionally internally protected and trapped nutrients, microorganisms, and/or enzymes. This process may allow for paced and slow release in the soil. In some instances, chemically bonded nutrients will be slowly released. Benefits from this composition include an increase in soil organic matter, enhancement of soil microorganism activity, and enrichment of soil by released nutrients. The biological active enhancer may in some instances lead to higher N. P. K and other nutrients accumulation, which may result in better growth, healthier crops, and higher yields.

### A. Components for Biological-Enhanced Fertilizers

Non-limiting examples of components of the biological-enhanced fertilizers include the following.

In some embodiments, a biological active enhancer is a microorganism that can be included in a biological-enhanced fertilizer. In some embodiments the microorganism can be a bacteria, archaea, fungi, or a protist. In some instances, the microorganism can include an endophyte, rhizosphere microbe, and/or phyllosphere microbe. In some embodiments, the microorganism can included more than one species of microorganism. In some embodiments, more than one species, genus, phylum, class, and/or kingdom can be represented in a group of microorganisms protected and/or included in a biological-enhanced fertilizer.

In some embodiments, a microorganism can be, but is not limited to, a diazotrophic bacteria, Azospirillum species, Azotobacter species. Frateuria aurantia, Bacillus species, endophytes, nitrogen fixing bacteria, siderophores producing microorganisms, methylotrophs, comammox (e.g., (COMplete AMMonia OXidation) an organism that can convert ammonia into nitrite and then into nitrate through the process of nitrification), phosphorus solubilizing, nitrite oxidizing. Nitrospira species, Methylobacterium species, and/or pink pigmented facultative methylotrophs (PPFM-trophs).

In some embodiments, a microorganism can be cultured and/or grown in a laboratory prior to addition to the fertilizer. In some embodiments, a microorganism can be obtained from a natural source. In some embodiments, a microorganism can be concentrated prior to addition to the fertilizer.

In some embodiments, a microorganism can be a spore/cyst forming microorganism, such as a spore/cyst forming bacteria. In some embodiments, a microorganism can be induced to form spores/cysts prior to addition to the fertilizer. In some embodiments, a microorganism is not induced to form spores/cysts prior to addition to the fertilizer. In some embodiments, a microorganism is not chemically induced to form spores/cysts prior to addition to the fertilizer. In some embodiments, a microorganism has been selected for heat tolerance. In some embodiments, a microorganism as not been selected for heat tolerance.

In some embodiments, a biological active enhancer is an enzyme that may be included in a biological-enhanced fertilizer. In some embodiments, the enzyme may be an enzyme that can break down the organic material. In some instances, the enzyme is an enzyme that may break down a polysaccharide. In some instances, the enzyme is an enzyme that may break down lignin or a modified lignin. In some instances, the enzyme is an enzyme that may break down cellulose or a modified cellulose. In some instances, the enzyme is a cellulase, a glucanase, a glucosidase, a glucanohydrolase, etc. In some instances, the enzyme is a ligninase, a lignase, a lignin-modifying enzyme, a peroxidase, a phenoloxidase, etc.

In some embodiments, the biological active enhancer is protected by addition of one or more physical protectants and/or by engineering methods (e.g., spray drying, freeze-drying, etc.). In some instances, the biological active enhancer is protected by an encapsulating agent, water-soluble additive (e.g., water-soluble protectants and/or water-soluble humectants), stabilizer additive, and/or a dispersant. In some embodiments, the biological active enhancer is encapsulated with a stabilizer. In some embodiments, the stabilizer comprises one or more of clay, diatomaceous earth, starch, agar, alginate, chitosan, PEG, PVA, polyacrylic acid, ethanol, humic acid, humates, talc, clay, peat, lignite, vermiculite, perlite and/or chemically modified versions of the same. In some embodiments, wherein the stabilizer is chemically modified, the chemical modification comprises one or more of esterification, alkylation, acetylation, phosphorylation, hydrophobic modification, sulfation, sulfomethylation, methylation, amidation, amination, protonation, halogenation, nitration, copolymerization, and/or physical or covalent cross-linking. In some embodiments, the stabilizer comprises calcium alginate and/or sodium alginate. In some embodiments, the water-soluble additive (e.g., water-soluble protectants and/or water-soluble humectants) comprises glycerol, carboxy methyl cellulose (CMC), polyvinyl pyrrolidone (PVP), gum Arabic, guar gum, and/or mono and/or disaccharide based CMC/Arabic gum/guar gum. In some embodiments, the biological active enhancer is contacted with a physical protectant, such as a encapsulating agent, water-soluble additive, stabilizer additive, and/or a dispersant. In some embodiments, the physical protectant is a molecule and/or enzyme derived from a thermophilic organism. In some embodiments, the physical protectant is diglycerol phosphate. In some embodiments, the biological active enhancer is protected by an engineering method. In some embodiments, the engineering method comprises spray drying and/or freeze-drying.

In some embodiments, the organic material is an organic material that may be included in a biological-enhanced fertilizer. In some embodiments, the organic material may be a cellulosic material and/or a lignin material. In some instances, the organic material is a modified cellulose and/or a modified lignin. In some instances, the organic material comprises cellulose, lignin, ethylcellulose, lignin-modified phenolic compounds, methylcellulose, hydroxypropyl cellulose, hydroxyethyl cellulose, carboxymethyl cellulose, products of ammoxidation of lignin, and/or products of Mannich reaction of lignin, etc.

In some embodiments the fertilizer is a commercially available fertilizer. In some embodiments, the fertilizer is produced by the methods disclosed herein, or produced during production of the biological-enhanced fertilizer. In some embodiments, the fertilizer may contain a nitrogen based fertilizer, a phosphate-based fertilizer, a potassium-based fertilizer, a urea-based fertilizer, a fertilizer providing nitrogen-phosphorus-potassium (NPK), a diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), potassium nitrate, a biowaste material, char, ashes from incineration of animal waste or animal tissues, or any combination thereof.

### B. Production of Ammonium Phosphate and Phosphorylated Organic Material

A non-limiting process for producing ammonium phosphate and phosphorylated organic material, such as cellulosic phosphate and/or lignin phosphate material is disclosed.

In some aspects, the process may be produced by the following reaction steps, using cellulose as an example:

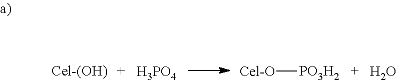

In step a) above, a cellulosic material or a lignin material is first provided. In some aspects, the cellulosic material is cellulose. The “Cel-OH” nomenclature employed herein depicts the non-limiting example of a polymeric cellulose backbone “Cel-” made up of a plurality of glucose units and hydroxyl groups “—OH” of the glucose units. A single “—OH” group is used above for clarity, however, a typical cellulose or lignin molecule will include hundreds to thousands of hydroxyl groups. The cellulosic material may be combined with phosphoric acid, for example, dissolving cellulose in phosphoric acid. The phosphoric acid can be 85 wt. % H₃PO₄ in H₂O, as a non-limiting example. Upon heating a mixture of a cellulosic material and phosphoric acid, a dehydrative coupling reaction may occur between a cellulosic hydroxyl group and the phosphoric acid molecule to provide cellulosic phosphate, such as “Cel-O—PO₃H₂”. On average, less than one, one, or more than one (e.g., two) cellulose hydroxyl group per glucose unit may react with one or more phosphoric acid molecule. Each internal glucose monomer within a cellulose polymeric chain can have up to three phosphate groups. Terminal glucose monomers at the ends of a cellulose polymeric chain can have up to four phosphate groups. Glucose monomers having a single phosphate group are depicted herein, for simplicity. The mixture may be heated at a temperature ranging from about 25° C. to about 200° C., preferably from about 30° C. to about 175° C., more preferably at a temperature of about 35° C. to 150° C. The reaction may be performed in a sealed vessel to prevent loss of water. One molecule of water “H₂O” is produced for every dehydrative coupling reaction between cellulose and phosphoric acid. In some aspects, the cellulose phosphate is in the form of a gel.

In addition to the dehydrative coupling between cellulose and phosphoric acid, some free phosphoric acid may remain unreacted and exist within the gelatinous cellulose phosphate.

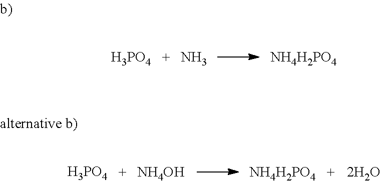

After, during, or before formation of cellulose phosphate, a source of ammonia is added to the mixture. The mixture of cellulose phosphate and excess phosphoric acid and source of ammonia may be heated at a temperature ranging from about 25° C. to about 170° C. preferably from about 30° C. to about 140° C., more preferably at a temperature of about 35° C. to 120° C. The excess phosphoric acid will react with the source of ammonia to form ammonium phosphate, such as monoammonium phosphate. In some instances, ammonia will abstract protons from cellulose phosphate “Cel-O—PO₃H₂” to provide ammonium cellulose phosphate “Cel-O—PO₃(NH₄)₂” (not shown). In some instances, when ammonium hydroxide is employed as the source of ammonia, hydroxide will abstract protons from cellulose phosphate to provide water and cellulose ammonium phosphate (not shown).

In some aspects, the cellulose phosphate and ammonium phosphate are produced in the same reaction vessel. In other aspects, the cellulose phosphate and ammonium phosphate are prepared separately and subsequently combined.

### C. Production of Potassium Nitrate and Nitrated Organic Material

A non-limiting process for producing potassium nitrate and nitrated organic material, such as cellulosic nitrate and/or lignin nitrate material is disclosed.

In some aspects, the process may be produced by the following reaction steps, using cellulose as an example:

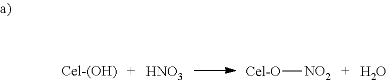

In step a) above, a cellulosic material or a lignin material is first provided. In some aspects, the cellulosic material is cellulose. The “Cel-OH” nomenclature employed herein depicts the non-limiting example of a polymeric cellulose backbone “Cel-” made up of a plurality of glucose units and hydroxyl groups “—OH” of the glucose units. A single “—OH” group is used above for clarity, however, a typical cellulose or lignin molecule will include hundreds to thousands of hydroxyl groups. The cellulosic material may be combined with nitric acid, for example, dissolving cellulose in nitric acid. The nitric acid can be 68 wt. % HNO₃ in H₂O, as a non-limiting example. Upon heating a mixture of a cellulosic material and nitric acid, a dehydrative coupling reaction may occur between a cellulosic hydroxyl group and the nitric acid molecule to provide cellulosic nitrate, such as “Cel-O—NO₂”. On average, less than one, one, or more than one (e.g., two) cellulose hydroxyl group per glucose unit may react with one or more nitric acid molecule. The mixture may be heated at a temperature ranging from about 25° C. to about 200° C., preferably from about 30° C. to about 175° C., more preferably at a temperature of about 35° C. to 150° C. The reaction may be performed in a sealed vessel to prevent loss of water. One molecule of water “H₂O” is produced for every dehydrative coupling reaction between cellulose and nitric acid. In some aspects, the cellulose nitrate is in the form of a gel.

In addition to the dehydrative coupling between cellulose and nitric acid, some free nitric acid may remain unreacted and exist within the gelatinous cellulose nitrate.

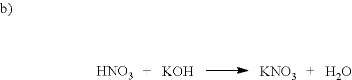

After, during, or before formation of cellulose nitrate, a source of potassium is added to the mixture. The mixture of cellulose nitrate and excess nitric acid and source of potassium may be heated at a temperature ranging from about 25° C. to about 170° C. preferably from about 30° C. to about 140° C., more preferably at a temperature of about 35° C. to 120° C. The excess nitric acid will react with the source of potassium to form potassium nitrate. In some aspects the source of potassium is one or more of potassium hydroxide (as shown in the non-limiting example above), potassium carbonate, potassium nitrate, potassium chloride, potassium phosphate, potassium sulfate, potassium bicarbonate, potassium oxide, potassium permanganate, potassium bromide, and/or potassium iodide.

In some aspects, the cellulose nitrate and potassium nitrate are produced in the same reaction vessel. In other aspects, the cellulose nitrate and potassium nitrate are prepared separately and subsequently combined.

### D. Methods of Making Fertilizers and Biological-Enhanced Fertilizers

The reactions depicted above when combined provide a fertilizer that includes N. P. and K nutrients (such as in the form of ammonium, nitrate, phosphate, and potassium) that may be chemically bonded to, physically absorbed, on the surface of, and/or encapsulated within the organic material (e.g., cellulosic, lignin material, cellulosic nitrate, cellulosic phosphate, lignin nitrate material, lignin phosphate material, etc.). Biological active enhancer may be found chemically bonded to, physically absorbed, on the surface of, and/or encapsulated within the organic material.

In some aspects, the reactions depicted above provide a mixture in the form of a gel. Water may then be removed from this gelatinous mixture to provide a solid form. Different techniques can be employed before, during, or after drying to provide the solid biological-enhanced fertilizer composition in powder, prill, granule, or pellet form.

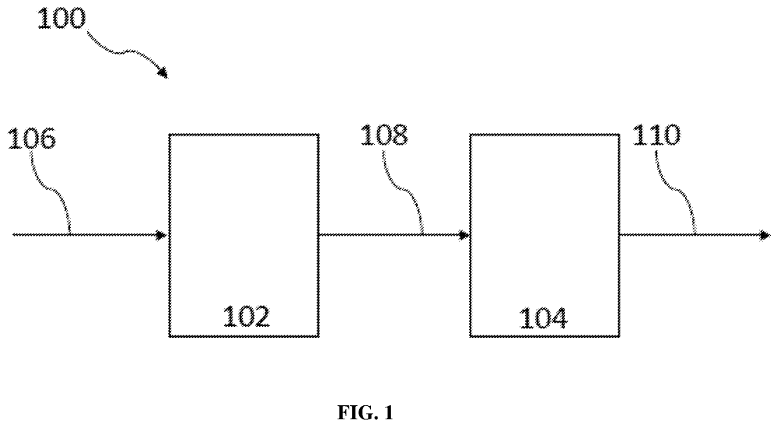

Referring to FIG. 1, a schematic of a system and method for making a fertilizer according to one example of the present invention is described. The system 100 can include a granulator 102 and a dryer 104. A feed mixture 106 can be granulated in the granulator 102 in the presence or absence of water to form a wet granulated mixture 108. The water, if present, can be provided with the feed mixture 106, and/or can be added separately to the granulator 102. The wet granulated mixture 108 can be dried in the dryer 104 to obtain dry granulated mixture 110 containing the fertilizer.

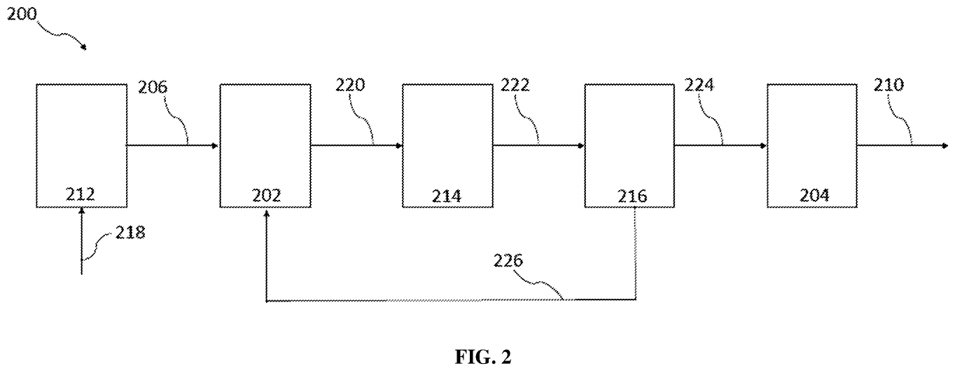

Referring to FIG. 2, a schematic of a system and method for making a fertilizer according to another example of the present invention is described. The system 200 can include a mixer/reactor 212, though the mixer and the reactor can be two, three, four, or more components, such as two reactors and a mixer or a reactor and a mixer. The system 200 can include a granulator 202, a spheronizer 214, one or more size screens 216, and a dryer 204, or any combination thereof. The feed mixture ingredients 218, separately and/or at any possible combination can be added to the mixer/reactor 212. In the mixer/reactor 212, the feed ingredients can be reacted and/or mixed to form the feed mixture 206. Feed mixture 206 can be granulated in the granulator 202 in presence or absence of additional water to form a wet granulated mixture 220. Granules of the wet granulated mixture 220 can be spheronized in the spheronizer 214 to form a wet granulated mixture 222 containing substantially spherical granules. The wet granulated mixture 222 can be passed through one or more size screens 216 to separate granules having a size smaller or bigger than a desired size from the wet granulated mixture 222 and obtain a wet granulated mixture 224 containing granules of desired size. At least a portion of the granules separated 226 from the granulation mixture 224 containing granules of desired size can be recycled to the granulator 202. The wet granulated mixture 224 containing granules of desired size can be dried in the dryer 204 to obtain dry granulated mixture 210 containing the fertilizer granule. In some aspects, the mixer/reactor 212 can contain a ribbon mixer.

The feed mixture ingredients 218 can include i) a K source, e.g., potassium hydroxide ii) a N source, e.g., nitric acid, NH₄⁺, NH₄OH, and/or NH₃, iii) a P source, e.g., phosphoric acid, iv) an organic material source. e.g., cellulosic and/or lignin material, and/or a v) biological active enhancer, e.g., a microorganism and/or enzyme. In some instances, a mixture ingredient provides more than one of N, P, K, organic material, and/or biological active enhancer. In some instances, a mixture ingredient provides additional nutrients and/or micronutrients, such as Ca, S, Mg, Fe, and/or Si. In certain aspects, one or more ingredients can be added as a water solution. In some instances, the mixture ingredients are provided as a powder. In some instances, one or more ingredients can be added as a gas. In some instances, the NH₃ is provided at a pressure above 1 bar, such as at, or between, or of any range of 1.2, 1.3, 1.4, 1.5, 2, 2.5, 3, 3.5, 4, 4.5, 5, 5.5, 6, 6.5, 7, 7.5, 8, 9, 10, 15, 20, 25, 30, 35, and 40 bar. In some instances, a portion of the mixture of ingredients is provided as a powder.

The feed mixture 106, 206 can contain N, P, K, organic material, and/or biological active enhancer. In some aspects, the feed mixture 106, 206 can contain biological active enhancer, organic material, HNO₃, (NH₄)₃PO₄, H₃PO₄, KOH, NH₃, and/or NH₄OH.

Water can be added to the feed mixture in the mixer/reactor 212 and/or in the granulator 102, 202. In certain aspects, 5 gm to 20 gm, or at least any one of, at most any one of, equal to any one of, or between any two 5, 6, 7, 8, 9, 10, 11, 12, 13, 14, 15, 16, 17, 18, 19, and 20 gm of water in total (e.g., added with one or more feed mixture ingredients and/or separately) can be added to the feed mixture, per 100 gm of feed mixture.

In some aspects, the granulator 102, 202 can be a drum granulator, pugmill granulator, pan granulator, solid mixer, abrasion drum, extruder, high-shear mixer granulator, roller granulator, mycromix, or a round bottom flask. In the granulator 102, 202 the feed mixture 106, 206 can be granulated by agglomeration, spray granulation, compaction, slurry granulation and/or high-shear mixer granulation. In some particular aspect, the feed mixture 106, 206 can be granulated in the granulator 102, 202 by compaction. In some aspects, the granulator 102, 202 can contain at least two rollers and compaction granulation can include compressing the feed mixture using the at least two rollers. In some aspects, the two rollers can be moved in counter current direction during compaction. In some aspects, the feed mixture can be compressed into shaped pellets, such as cylindrical pellets, by the at least two rollers. In some aspects, a surface of one roller can have desired holes to compress the feed mixture into the holes, and the surface of the other roller can push the feed mixture into the holes. Pressure during granulation. e.g. compaction granulation can be 1 bar to 40 bar, or at least any one of, at most any one of, equal to any one of, or between any two 1, 2, 3, 4, 5, 10, 15, 20, 25, 30, 35, and 40 bar. In certain aspects, the feed mixture can be granulated in the granulator 102, 202 at ambient temperature to 50° C., or at least any one of, at most any one of, equal to any one of, or between any two of −20, −15, −10, 0, 5, 10, 15, 20, 25, 30, 35, 40, 45, and 50° C.

In some aspects, reacting of the feed mixture ingredients, mixing, and granulating the feed mixture can be performed in different containers, e.g., the mixer/reactor 212 and the granulator 202 can be different containers. In some aspects, reacting of the feed mixture ingredients, mixing, and granulating the feed mixture can be performed in the same container, e.g., the mixer/reactor 212 and the granulator 202 can be the same container (not shown). In some aspects, the mixer/reactor 212 and the granulator 202 can be more than two containers. As non-limiting examples, in some instances, the NH₄H₂PO₄ and KNO₃ are formed in two different containers. In some instances, the NH₄H₂PO₄ and KNO₃ are formed in one container. In some instances, the KNO₃ and nitrate modified organic material are formed in two different containers. In some instances, the KNO₃ and nitrate modified organic material are formed in one container. In some instances, the NH₄H₂PO₄ and phosphate modified organic material are formed in two different containers. In some instances, the NH₄H₂PO₄ and phosphate modified organic material are formed in one container. In some instances, the NH₄H₂PO₄ and KNO₃ are formed in two different containers and the KNO₃ and nitrate modified organic material are formed in one container and the NH₄H₂PO₄ and phosphate modified organic material are formed in one container. In some instances, the KNO₃ and nitrate modified organic material are formed in two different containers and the NH₄H₂PO₄ and phosphate modified organic material are formed in two different containers. In some instances, the NH₄H₂PO₄, phosphate modified organic material. KNO₃, and nitrate modified organic material are formed in one container. In some instances, the NH₄H₂PO₄, phosphate modified organic material, KNO₃, and nitrate modified organic material are each formed in a different container.

In some instances, the fertilizer can be extruded before drying. The extruder can extrude the fertilizer at pressures at least, at most, equal to, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 bar. The extruder can extrude the fertilizer at temperatures at least, at most, equal to, or between any two of −20, −15, −10, 0, 5, 10, 15, 20, 25, 30, 35, 40, 45 and 50° C. The extrudate can be sliced or divided before drying, such as by a die.

In certain aspects, the desired size of a final fertilizer product, such as a granule, can be 0.5 to 5 mm, or 1 to 4 mm, and having a size lower than 0.5 mm or 1 mm, and/or having a size bigger than 4 mm or 5 mm can be separated from the wet granulated mixture 222 in the one or more size screens 216. In certain aspects, the wet granulated mixture can be rounded and/or spheronized in a spheronizer. In some instances, the wet granulated mixture is contacted with a spheronizer for at least any one of, at most any one of, equal to any one of, or between any two of 5, 10, 15, 20, 25, 30, 35, 40, 50, or 60 seconds. The spheronizer in some instances has a rotating or rotatable disk capable of rotating at least any one of, at most any one of, equal to any one of, or between any two of 200, 500, 1000, 1500, 2000, 2500, 3000, 3500, 4000, 4500, and 5000 rpm. In certain aspects, the wet granulated mixture can be dried in the dryer 104, 204 at a temperature 40° C. to 150° C., or at least any one of, at most any one of, equal to any one of, or between any two of 40, 45, 50, 55, 60, 65, 70, 75, 80, 85, 90, 95, 100, 105, 110, 115, 120, 125, 130, 135, 140, 145, 150° C. In some aspects, the dryer 104, 204 can be a fluid bed dryer, drum dryer, or flash dryer. In some aspects, the wet granulated mixture can be dried in the dryer 104, 204 with a hot air flow having a flow rate of at least any one of, at most any one of, equal to any one of, or between any two of 100, 150, 200, 250, 300, 350, 400, 450, and 500 m³/hr and/or a rotation of at least any one of, at most any one of, equal to any one of, or between any two of 5, 10, 15, 20, 25, 30, 35, 40, 45, and 50 rpm.

In some embodiments, a biological active enhancer is contacted with a fertilizer and/or organic material by spraying onto a fertilizer particle, organic material, and/or granule, by mixing into a fertilizer and/or organic material, by spraying a fertilizer and/or organic material onto the biological active enhancer, by coating a fertilizer and/or organic material, by being coated by a fertilizer and/or organic material, by being encapsulated in a fertilizer matrix and/or organic material matrix, by encapsulating a fertilizer and/or organic material to form a matrix of the biological active enhancer, etc.

In some embodiments, a biological active enhancer is contacted with a fertilizer and/or organic material using a spray, liquid stream, semi-solid, or solid (such as a powder) comprising said biological active enhancer. In some embodiments, a biological active enhancer is contacted using a dosage pump or a spray head.

In some embodiments, a biological active enhancer is concentrated (e.g., settlement, centrifugation, affinity capture, selective growth media, etc.,) prior to contact with a fertilizer and/or organic material to form a biological-enhanced fertilizer. In some embodiments, a biological active enhancer that is a microorganism is contacted with the fertilizer and/or organic material at a concentration of 10⁴-10¹² cells per gram of the biological-enhanced fertilizer. In some preferred embodiments, a biological active enhancer is contacted with the fertilizer and/or organic material at a concentration of 10⁸-10⁹ cells per gram of the biological-enhanced fertilizer. In some embodiments, a biological active enhancer is comprised in a liquid, suspension, and/or dried powder.

In some embodiments, a biological-enhanced fertilizer can contain low amounts of moisture. In some embodiments, a free-moisture content of a biological-enhanced fertilizer can be less than 0.6 wt. %, less than 0.5 wt. % water or 0.25 wt. % to less than 0.6 wt. % water. In some instances, the free moisture content is 0.5, 0.4, 0.3, 0.2, 0.1, or 0 wt. %.

In some embodiments, a biological-enhanced fertilizer can be comprised of one or more particles. In some embodiments, a first plurality of the particles can be a fertilizer, and a second plurality of the particles can be biological active enhancer(s) and/or an organic material. In some instances, a particle can contain a fertilizer, an organic material, and a biological active enhancer.

In certain non-limiting embodiments, particles can have an average particle size of 1, 2, 3, 4, 5, 6, 7, 8, 9, 10, 11, 12, 13, 14, 15, 20, 30, 40, 50, 60, 70, 80, 90, 100, 200, 300, 400, 500, 600, 700, 800, or 900 micrometers or any size there between. In some embodiments, particles can be elongated particles or can be substantially spherical particles or other shapes, or combinations of such shapes. Non-limiting examples of shapes include a sphere, a puck, an oval, a rod, an oblong, or a random shape.

In some embodiments, 40 wt. % to 99.8 wt. % or 55 wt. % to 99.8 wt. % or at least one of, equal to any one of, or between any two 40, 45, 50, 55, 60, 65, 70, 75, 80, 85, 90, 95, 96, 97, 98, 99, 99.5, or 99.8 wt. % of a biological-enhanced fertilizer can be comprised of a fertilizer.

In some embodiments, a biological-enhanced fertilizer particle can have a crush strength of 1, 2, 3, 4, 5, 6, 7, 8, 9, 10 kgf/particle, or more, or any amount there between, preferably 2 kgf/particle to 5 kgf/particle.

In some embodiments, a biological-enhanced fertilizer can contain a coating on the surface of one or more particles. In some instances, the coating can include one or more biological active enhancer, nutrients for a plant, inhibitors of urea hydrolysis and/or nitrification, agents to slow or increase the rate of degradation of the granule and/or fertilizers, agents to repel moisture and/or provide a hydrophobic layer, agents that decrease or increase the reactivity of the granule and/or fertilizers, agents that provide additional benefits to plants, agents that increase the stability and/or crush strength of the granule and/or fertilizers, pH buffering agents, drying agents, etc. or any combination thereof. The coating can be a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound.

As shown in FIG. 3 as a non-limiting example, a biological-enhanced fertilizer (300) can comprise a homogenous combination of a fertilizer, an organic material, and at least one biological active enhancer capable of breaking down the organic material.

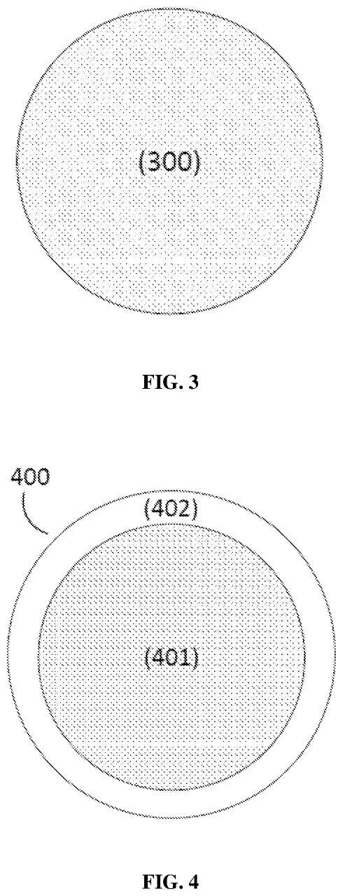

As shown in FIG. 4 as a non-limiting example, a biological-enhanced fertilizer (400) can comprise a core (401) with a homogenous combination of fertilizer, an organic material, and at least one biological active enhancer and a coating (402) at least partially surrounding the core, where the coating contains a biological active enhancer. In some embodiments, the core (401) does not contain a biological active enhancer. In some embodiments, the coating (402) is a fertilizer coating, such as urea.

### E. Methods of Using Biological-Enhanced Fertilizers

In some embodiments, biological-enhanced fertilizer compositions of the present disclosure can be used in methods of increasing the amount of one or more nutrients and one or more biological active enhancer in soil, and of enhancing plant growth. In some embodiments, methods can include applying to the soil an effective amount of a composition containing biological-enhanced fertilizers of the present disclosure. In some embodiments, methods may include increasing the growth and yield of crops, trees, ornamentals, etc. such as, for example, palm, coconut, rice, wheat, corn, barley, oats, and soybeans. In some embodiments, methods can include applying a biological-enhanced fertilizer of the present disclosure to at least one of a soil, an organism, a liquid carrier, a liquid solvent, etc.

In some embodiments, a biological-enhanced fertilizer can be stored. In some embodiments, the biological-enhanced fertilizer can be stored for any amount of time, such as 1 minute, 10 minutes, 30 minutes, 1 hour, 2 hours, 4 hours, 8 hours, 12 hours, 16 hours, 1 day, 2 days, 5 days, 1 week, 2 weeks, 3 weeks, 4 weeks, 1 month, 2 months, 3 months, 4 months, 5 months, 6 months, 1 year, 2 years, 3 years, 4 years, 5 years or more, or any amount of time or range thereof or there between without 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% of the biological active enhancers in the biological-enhanced fertilizer being degraded or dying.

In some embodiments, once a biological-enhanced fertilizer is applied to a target substrate, the organic materials degrade enhanced by the biological active enhancer and release the biological active enhancer and/or fertilizer to deliver their bio-effects.

In some embodiments, the effectiveness of compositions comprising biological-enhanced fertilizers of the present invention can be ascertained by measuring the amount of particular nutrients in the soil at various times after applying the biological-enhanced fertilizer composition to the soil. In some embodiments, the effectiveness of compositions comprising biological-enhanced fertilizers of the present invention can be ascertained by measuring the amount of a microorganism and/or enzyme in the soil at various times after applying the biological-enhanced fertilizer composition to the soil. It is understood that different soils have different characteristics, which can affect the stability of nutrients, enzymes, and microorganisms in the soil. In some embodiments, effectiveness of a biological-enhanced fertilizer composition can be directly compared to other fertilizer compositions by doing a side-by-side comparison in the same soil under the same conditions.

In some embodiments, biological-enhanced fertilizers according to the present disclosure can have a density that is greater than water. This can allow the granules and/or fertilizers to sink in water rather than float. This can be especially beneficial in instances where application is intended to a crop that is at least partially or fully submerged in water. A non-limiting example of such a crop is rice, as the ground in a rice paddy is typically submerged in water. Thus, application of biological-enhanced fertilizers to such crops can be performed so that granules and/or fertilizer are homogenously distributed on the ground that is submerged.

F. Compositions with Biological-Enhanced Fertilizers and Characteristics Thereof

In some embodiments, biological-enhanced fertilizers of the present disclosure can also be included in a blended or compounded fertilizer composition comprising other fertilizers, such as other fertilizer granules. Additional fertilizers can be chosen based on the particular needs of certain types of soil, climate, or other growing conditions to maximize the efficacy of the biological-enhanced fertilizer in enhancing plant growth and crop yield. The other fertilizer granules can be granules of urea, single super phosphate (SSP), triple super phosphate (TSP), ammonium sulfate, monoammonium phosphate (MAP), diammonium phosphate (DAP), muriate of potash (MOP), and/or sulfate of potash (SOP), and the like.

In some embodiments, biological-enhanced fertilizers described herein can be used alone or in combination with other fertilizer actives and micronutrients. In some embodiments, the other fertilizer actives and micronutrients can be added with any of the ingredients at the beginning of the drying stage or granulation process or at any later stage.

Non-limiting examples of additional additives can be micronutrients, primary nutrients, and secondary nutrients. A micronutrient is a botanically acceptable form of an inorganic or organometallic compound such as boron, copper, iron, chloride, manganese, molybdenum, nickel, or zinc. A primary nutrient is a material that can deliver nitrogen, phosphorous, and/or potassium to a plant. Nitrogen-containing primary nutrients may include urea, ammonium nitrate, ammonium sulfate, diammonium phosphate, monoammonium phosphate, urea-formaldehyde, or combinations thereof. A secondary nutrient is a substance that can deliver calcium, magnesium, and/or sulfur to a plant. Secondary nutrients may include lime, gypsum, superphosphate, or a combination thereof. For example, in some instances the biological-enhanced fertilizer composition can contain calcium sulfate, potassium sulfate, magnesium sulfate or a combination thereof.

In some embodiments, biological-enhanced fertilizer compositions of the present disclosure can comprise one or more inhibitors. In some embodiments, an inhibitor can be a urease inhibitor or a nitrification inhibitor, or a combination thereof. In some embodiments, a urease inhibitor and a nitrification inhibitor are included. In some embodiments, an inhibitor can be a urease inhibitor. Suitable urease inhibitors include, but are not limited to, N-(n-butyl) thiophosphoric triamide (NBTPT) and phenylphosphorodiamidate (PPDA). In some embodiments, a biological-enhanced fertilizer composition can comprise NBTPT or PPDA, or a combination thereof. In some embodiments, an inhibitor can be a nitrification inhibitor. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In some embodiments, a nitrification inhibitor can comprise DMPP, DCD, TU, nitrapyrin, 5-ethoxy-3-trichloromethyl-1,2,4-thiadiazol, AM, MBT, or ST, or a combination thereof. In some embodiments, a biological-enhanced fertilizer composition can comprise NBTPT, DMPP, TU, DCD, PPDA, nitrapyrin, 5-ethoxy-3-trichloromethyl-1,2,4-thiadiazol, AM, MBT, ST, or a combination thereof.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

15 g potassium hydroxide was dissolved in 100 ml water and to the solution was added 50 g cellulose powder and the mixture was stirred at 35° C. for 2 hours. 55.6 g nitric acid with concentration 68% was diluted with water to a final volume of 120 ml, and this solution was added to a mixture of cellulose+potassium hydroxide; the stirring continued for another 2 hours to form a first gel.

Separately, 50 g cellulose powder was mixed with 60.4 g phosphoric acid which was diluted with water to a volume of 100 ml. The mixture was stirred 2 hours at 35° C. The reaction mixture was fed NH₃ at a flow rate of 25 cc/min for 3 hours. The resulting product was then mixed with the first gel. The final mixture was stirred for 1 hour to obtain a final gel.

0.1 ml of a microbe formulation was added to the final gel with gentle stirring for 30 minutes to form a gel-paste product. The gel-paste product was granulated and dried at 40-45° C. Granules can then be coated with the same or a different microbial formulation.

The content of nutrients in the final product was as follows: N (10%), P as P₂O₅ equivalents (20%), and K as K₂O equivalents (10%). The final product has the advantages of: three-in-one bio-organic- and chemical; low carbon footprint; organic value to soil health; bio-powered high nutrient use efficiency; slow mineral and microbial release; microbial compatibility and protection; and two phases-release.

1. A biological-enhanced fertilizer composition comprising:
a fertilizer;
a cellulose comprising nitrate moieties;
at least one biological active enhancer capable of breaking down the cellulose comprising nitrate moieties.

2. (canceled)

3. The biological-enhanced fertilizer composition of claim 1, wherein at the least one biological activity enhancer comprise one or more of a microbe or an enzyme.

4. The biological-enhanced fertilizer composition of claim 1, wherein the at least one biological activity enhancer comprises an enzyme.

5. The biological-enhanced fertilizer composition of claim 1, wherein the at least one biological activity enhancer comprises a microbe.

6. The biological-enhanced fertilizer composition of claim 1, wherein the fertilizer comprises one or more of a nitrogen fertilizer, a phosphorus fertilizer, a potassium fertilizer, a calcium plant nutrient, a magnesium plant nutrient, a sulfur plant nutrient, an iron plant nutrient, a copper plant nutrient, a zinc plant nutrient, or a manganese plant nutrient.

7. The biological-enhanced fertilizer composition of claim 1, wherein the cellulose comprising nitrate moieties at least partially surrounds at least a portion of the fertilizer.

8. The biological-enhanced fertilizer composition of claim 1, wherein the cellulose comprising nitrate moieties at least partially surrounds at least one biological active enhancer.

9. The biological-enhanced fertilizer composition of claim 1, wherein at least one biological active enhancer at least partially coats the cellulose comprising nitrate moieties.

10. The biological-enhanced fertilizer composition of claim 1, wherein at least one biological active enhancer at least partially coats the cellulose comprising nitrate moieties and wherein the cellulose comprising nitrate moieties at least partially surrounds at least one biological active enhancer.

11. The biological-enhanced fertilizer composition of claim 10, wherein the at least one biological active enhancer at least partially coated by the cellulose comprising nitrate moieties is a different biological active enhancer than the at least one biological active enhancer that at least partially surrounded by the cellulose comprising nitrate moieties.

12. The biological-enhanced fertilizer composition of claim 1, wherein the fertilizer comprises one or more of urea, diammonium phosphate, potassium sulfate, and/or a nitrogen phosphorus potassium (NPK) mix.

13. The biological-enhanced fertilizer composition of claim 1, wherein the fertilizer comprises one or more of monoammonium phosphate, potassium nitrate, and/or a cellulose comprising phosphate moieties.

14. A method of making a biological-enhanced fertilizer composition of claim 1, the method comprising:
combining the fertilizer, the cellulose comprising nitrate moieties, and the at least one biological active enhancer; and
drying to form the biological-enhanced fertilizer composition.

15. The method of claim 14, wherein the at least one biological active enhancer is combined with the cellulose comprising nitrate moieties by mixing the at least one biological active enhancer and the cellulose comprising nitrate moieties to at least partially surround the at least one biological active enhancer with the cellulose comprising nitrate moieties.

16. The method of claim 14, wherein the at least one biological active enhancer is combined with the cellulose comprising nitrate moieties by at least partially coating the cellulose comprising nitrate moieties with the at least one biological active enhancer.

17. The method of claim 14, wherein the method further comprises reacting cellulose with nitric acid to form the cellulose comprising nitrate moieties.

18. The method of claim 14, wherein the fertilizer comprises monoammonium phosphate and/or potassium nitrate, and wherein the method further comprises reacting phosphoric acid with a source of ammonia to form the monoammonium phosphate and/or reacting potassium hydroxide with nitric acid to form the potassium nitrate.

19. The method of claim 14, wherein the fertilizer is combined with the cellulose comprising nitrate moieties by mixing the fertilizer and the cellulose comprising nitrate moieties to at least partially surround the fertilizer with the cellulose comprising nitrate moieties.

20. A method for fertilizing agricultural crops comprising applying the biological-enhanced fertilizer composition of claim 1 to a soil, a crop, or a soil and a crop.
